(19) United States
(12) Patent Application Publication
(10) Pub. No.: US 2003/0012410 A1
(43) Pub. Date: Jan. 16, 2003

(54) Tracking and pose estimation for augmented reality using real features

(76) Inventors: Nassir Navab, Plainsboro, NJ (US); Yakup Genc, Plainsboro, NJ (US); Visvanathan Ramesh, Plainsboro, NJ (US); Dorin Comaniciu, Princeton, NJ (US)

Correspondence Address: Siemens Corporation, Intellectual Property Department, 186 Wood Avenue South, Iselin, NJ, 08830, US

(21) Appl. No.: 10/188,396

(22) Filed: Jul. 2, 2002

Related U.S. Application Data
(60) Provisional application No. 60/304,395, filed on Jul. 10, 2001.

(51) Int. Cl. G06K 9/00

(52) U.S. Cl. 382/103

(57) ABSTRACT

A method and system for tracking a position and orientation (pose) of a camera using real scene features is provided. The method includes the steps of capturing a video sequence by the camera; extracting features from the video sequence; estimating a first pose of the camera by an external tracking system; constructing a model of the features from the first pose; and estimating a second pose by tracking the model of the features, wherein after the second pose is estimated, the external tracking system is eliminated. The system includes an external tracker for estimating a reference pose; a camera for capturing a video sequence; a feature extractor for extracting features from the video sequence; a model builder for constructing a model of the features from the reference pose; and a pose estimator for estimating a pose of the camera by tracking the model of the features.

This application claims priority to an application entitled “AN AUTOMATIC SYSTEM FOR TRACKING AND POSE ESTIMATION: LEARNING FROM MARKERS OR OTHER TRACKING SENSORS IN ORDER TO USE REAL FEATURES” filed in the United States Patent and Trademark Office on Jul. 10, 2001 and assigned Ser. No. 60/304,395, the contents of which are hereby incorporated by reference.

### BACKGROUND OF THE INVENTION

1. Field of the Invention

The present invention relates generally to augmented reality systems, and more particularly, to a system and method for determining pose (position and orientation) estimation of a user and/or camera using real scene features.

2. Description of the Related Art

Augmented reality (AR) is a technology in which a user's perception of the real world is enhanced with additional information generated from a computer model. The visual enhancements may include labels, three-dimensional rendered models, and shading and illumination changes. Augmented reality allows a user to work with and examine the physical world, while receiving additional information about the objects in it through a display, e.g., a monitor or head-mounted display (HMD).

In a typical augmented reality system, a user's view of a real scene is augmented with graphics. The graphics are generated from geometric models of both virtual objects and real objects in the environment. In order for the graphics and the scene to align properly, i.e., to have proper registration, the pose and optical properties of the real and virtual cameras must be the same.

Estimating the pose of a camera (virtual or real), on which some augmentation takes place, is the most important part of an augmented reality system. This estimation process is usually called tracking. It is to be appreciated that virtual and augmented reality (VR and AR) research communities use the term “tracking” in a different context than the computer vision community. Tracking in VR and AR refers to determining the pose, i.e., three-dimensional position and orientation, of the camera and/or user. Tracking in computer vision means data association, also called matching or correspondence, between consecutive frames in an image sequence.

Many different tracking methods and systems are available including mechanical, magnetic, ultrasound, inertial, vision-based, and hybrid systems that try to combine the advantages of two or more technologies. Availability of powerful processors and fast frame grabbers has made the vision-based trackers the method of choice mostly due to their accuracy as well as flexibility and ease of use. Although very elaborate object tracking techniques exist in computer vision, they are not practical for pose estimation. The vision-based trackers used in AR are based on tracking of markers placed in a scene. The use of markers increases robustness and reduces computation requirements. However, their use can be complicated, as they require certain maintenance. For example, placing a marker in the workspace of the user can be intrusive and the markers can from time to time need recalibration.

Direct use of scene features for tracking instead of the markers is much more desirable, especially, when certain parts of the workspace do not change in time. For example, a control panel in a specific environment or workspace has fixed buttons and knobs that remains the same over its lifetime. The use of these rigid and unchanging features for tracking simplifies the preparation of the scenarios for scene augmentation as well.

Attempts to use scene features other than the specially designed markers have been made in the prior art. Most of these were limited to either increasing the accuracy of other tracking methods or to extend the range of the tracking in the presence of a marker-based tracking system or in combination with other tracking modalities (hybrid systems).

Work in computer vision has yielded very fast and robust methods for object tracking. However, these are not particularly useful for accurate pose estimation that is required by most AR applications. Pose estimation for AR applications requires a match between a three-dimensional model and its image. Object tracking does not necessarily provide such a match between the model and its image. Instead, it provides a match between the consecutive views of the object.

### SUMMARY OF THE INVENTION

It is therefore an object of the present invention to provide a system and method for determining pose estimation by utilizing real scene features.

It is another object of the present invention to provide a method for determining pose estimation in an augmented reality system using real-time feature tracking technology.

To achieve the above and other objects, a new system and method for tracking the position and orientation (i.e., pose) of a camera observing a scene without any visual markers is provided. The method of the present invention is based on a two-stage process. In the first stage, a set of features in a scene is learned with the use of an external tracking system. The second stage uses these learned features for camera tracking when the estimated pose is in an acceptable range of a reference pose as determined by the external tracker. The method of the present invention can employ any available conventional feature tracking and pose estimation system for the learning and tracking processes.

According to one aspect of the present invention, a method for determining a pose of a camera is provided including the steps of capturing a video sequence by the camera, the video sequence including a plurality of frames; extracting a plurality of features of an object in the video sequence; estimating a first pose of the camera by an external tracking system; constructing a model of the plurality of features from the estimated first pose; and estimating a second pose of the camera by tracking the model of the plurality of features, wherein after the second pose is estimated, the external tracking system is eliminated. The extracting a plurality of features step may be performed in real time or on a recorded video sequence. Furthermore, the method includes the step of evaluating correspondences of the plurality of features over the plurality of frames of the video sequence to determine whether the plurality of features are stable. The method further includes the steps of comparing the second pose to the first pose; and wherein if the second pose is within an acceptable range of the first pose, eliminating the external tracking system.

According to another aspects of the present invention, a system for determining a pose of a camera is provided. The system includes an external tracker for estimating a reference pose; a camera for capturing a video sequence; a feature extractor for extracting a plurality of features of an object in the video sequence; a model builder for constructing a model of the plurality of features from the estimated reference pose; and a pose estimator for estimating a pose of the camera by tracking the model of the plurality of features. The system further includes an augmentation engine operatively coupled to a display for displaying the constructed model over the plurality of features.

In a further aspect of the present invention, the system includes a processor for comparing the pose of the camera to the reference pose and, wherein if the camera pose is within an acceptable range of the reference pose, eliminating the external tracking system.

In another aspect of the invention, external tracker of the system for determining the pose of a camera is a marker-based tracker wherein the reference pose is estimated by tracking a plurality of markers placed in a workspace. Additionally, the system includes a processor for comparing the pose of the camera to the reference pose and, if the camera pose is within an acceptable range of the reference pose, instructing a user to remove the markers.

In yet another aspect, a program storage device readable by machine, tangibly embodying a program of instructions executable by the machine to perform method steps for determining a pose of a camera is provided, where the method steps include capturing a video sequence by the camera, the video sequence including a plurality of frames; extracting a plurality of features of an object in the video sequence; estimating a first pose of the camera by an external tracking system; constructing a model of the plurality of features from the estimated first pose; and estimating a second pose of the camera by tracking the model of the plurality of features, wherein after the second pose is estimated, the external tracking system is eliminated.

In another aspect of the present invention, an augmented reality system is provided. The augmented reality system includes an external tracker for estimating a reference pose; a camera for capturing a video sequence; a feature extractor for extracting a plurality of features of an object in the video sequence; a model builder for constructing a model of the plurality of features from the estimated reference pose; a pose estimator for estimating a pose of the camera by tracking the model of the plurality of features; an augmentation engine operatively coupled to a display for displaying the constructed model over the plurality of features; and a processor for comparing the pose of the camera to the reference pose and, wherein if the camera pose is within an acceptable range of the reference pose, eliminating the external tracking system.

### BRIEF DESCRIPTION OF THE DRAWINGS

The above and other objects, features, and advantages of the present invention will become more apparent in light of the following detailed description when taken in conjunction with the accompanying drawings in which:

FIG. 1 is a schematic diagram illustrating an augmented reality system with video-based tracking;

FIG. 2A is a flowchart illustrating the learning or training phase of the method for determining pose estimation in accordance with the present invention where a set of features are learned using an external tracking system;

FIG. 2B is a flowchart illustrating the tracking phase of the method of the present invention where learned features are used for tracking;

FIG. 3 is a block diagram of an exemplary system for carrying out the method of determining pose estimation in accordance with the present invention;

FIGS. 4A and 4B illustrate several views of a workspace where tracking is to take place, where FIG. 4A illustrates a control panel in a workspace and FIG. 4B illustrates the control panel with a plurality of markers placed thereon to be used for external tracking; and

FIGS. 5A and 5B illustrate two three-dimensional (3D) views of reconstructed 3D points of the control panel shown in FIG. 4.

### DETAILED DESCRIPTION OF THE PREFERRED EMBODIMENTS

Preferred embodiments of the present invention will be described hereinbelow with reference to the accompanying drawings. In the following description, well-known functions or constructions are not described in detail to avoid obscuring the invention in unnecessary detail.

Generally, an augmented reality system includes a display device for presenting a user with an image of the real world augmented with virtual objects, e.g., computer-generated graphics, a tracking system for locating real-world objects, and a processor, e.g., a computer, for determining the user's point of view and for projecting the virtual objects onto the display device in proper reference to the user's point of view.

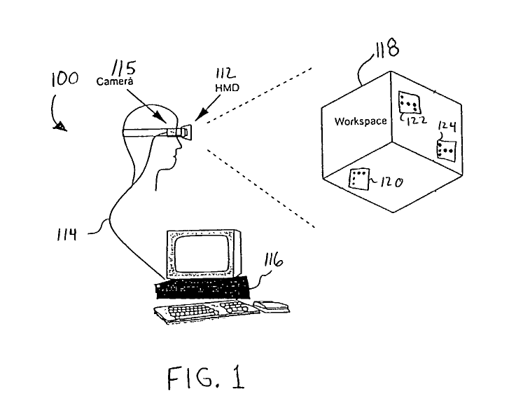

Referring to FIG. 1, an exemplary augmented reality (AR) system 100 to be used in conjunction with the present invention is illustrated. The AR system 100 includes a head-mounted display (HMD) 112, a video-based tracking system 114 and a processor 116, here shown as a desktop computer. For the purposes of this illustration, the AR system 10 will be utilized in a specific workspace 118 which includes several markers 120, 122, 124 located throughout.

The tracking system 114 used in conjunction with processor 116 determines the position and orientation of a user's head and subsequently a scene the user is viewing. Generally, the video-based tracking system 114 includes a camera 115, a video capture board mounted in the processor 116, and a plurality of markers 120, 122, 124, e.g., a square tile with a specific configuration of circular disks. Video obtained from the camera 115 through the capture board is processed in the processor 116 to identify the images of the markers. Since the configuration and location of the markers are known within a specific workspace 118, the processor 116 can determine the pose of the user. The above-described tracking system is also referred to as a marker-based tracking system.

1. System Definition and Overview

The system and method of the present invention uses real scene features for estimating the pose of a camera. The system allows the user to move from using markers or any applicable tracking and pose estimation methods to using real features through an automatic process. This process increases the success of the overall registration accuracy for the AR application, i.e., alignment of real and virtual objects.

The basic idea is to first use the markers or any applicable external tracking device for pose and motion estimation. A user could start using the system in his or her usual environment, e.g., a workspace. As the user works with the system, an automated process runs in the background extracting and tracking features in the scene. This process remains hidden until the system decides to take over the pose estimation task from the other tracker. The switchover occurs only after a certain number of salient features are learned and the pose obtained from these features is as good as the pose provided by the external tracker. The automated process has two phases, i.e., (i) learning, and (ii) tracking for pose estimation.

1.1 Learning

For a vision-based tracking system, a model is needed which is matched against images for estimating the pose of the camera taking the images. In the method of the present invention, an automated process is used to learn the underlying model of the workspace where the tracking is going to take place.

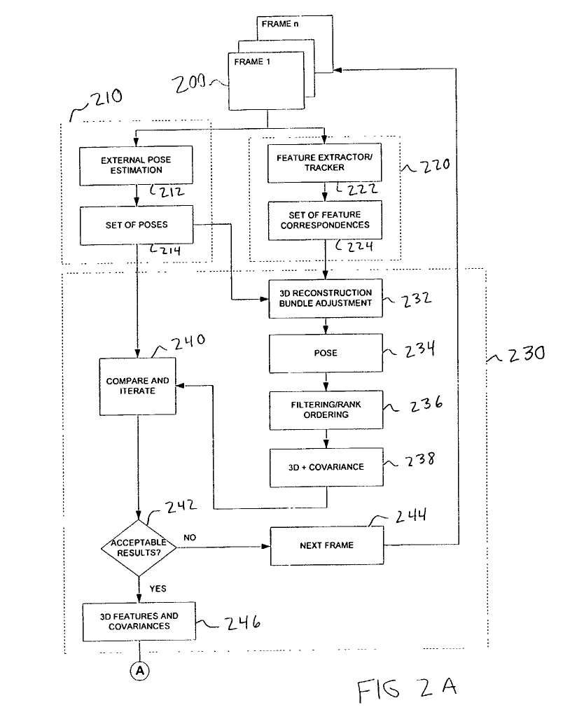

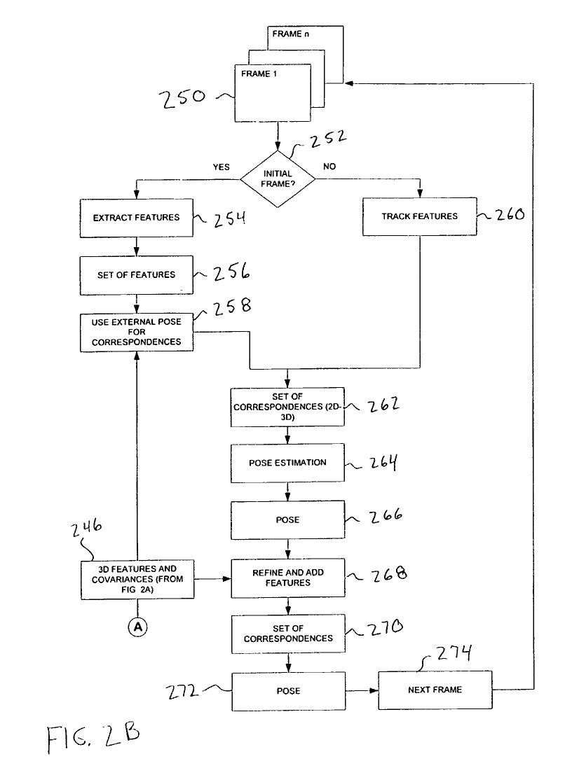

FIG. 2A is a flowchart illustrating the learning or training phase of the method for determining pose estimation in accordance with the present invention where a set of features are learned using an external tracking system. This phase of the present invention includes three major steps or subprocesses: (i) external tracking 210; (ii) feature extracting and tracking 220; and (iii) feature learning or modeling.

While the augmented reality system together with an external tracking system is in use, the system captures a video sequence (step 200), including a plurality of frames, and uses conventional feature extraction and tracking methods to detect reliable features (step 222). These may include basic features such as points, lines, and circles of objects in the scene, planar patches or composite features such as polygons, cylinders etc. Depending on the performance of the system, the feature extraction (step 220) can be done in real time or on recorded videos along with the pose as provided by the external tracking system. The system tracks each feature in the video stream and determines a set of feature correspondences (step 224). Meantime, the system is using the captured video for pose estimation (step 212), e.g., by tracking markers, and generating a pose estimation for each frame (step 214). Once a feature is reasonably tracked over a number of frames, the system uses the 6 DOF (six degree-of-freedom) pose provided by the existing tracking system (step 214) to obtain a 3D model for this particular feature (step 232).

At this point, the feature tracking, for this particular feature, becomes a mixed 2D-2D and 3D-2D matching and bundle adjustment problem. The tracked features over a set of images constitute the 2D-2D matches, e.g., the image (2D) position of a corner point is tracked over a number of frames. Using these 2D-2D matches and the pose provided by the external tracker yields a reconstruction of the 3D locations of each features. This reconstruction is obtained by the standard technique of triangulation as is known in the art of computer vision and photogrammetry. The reconstructed location and the image locations of each feature forms the 2D-3D matches. An optimization method, called bundle adjustment in photogrammetry, is used to refine the reconstruction of the 3D location of each feature. A pose for each of the frames in the sequence is then obtained by matching the 2D locations of the features to the reconstructed 3D locations (step 234).

A filtering and rank ordering process (step 236) allows the merging of features that are tracked in different segments of the video stream and the elimination of outlier features. The outliers are features that are not tracked accurately due to occlusion, etc. A feature can be detected and tracked for a period of time and can be lost due to occlusion. It can be detected and tracked again for a different period of time in another part of the sequence. Filtering and rank ordering allows the system to detect this type of partial tracked features. After filtering and rank ordering, uncertainties can be computed for each 3D reconstruction, i.e., covariance (step 238). Combined, steps 232 through 238 allow the system to evaluate each set of feature correspondences in order to define whether the feature is a stable one, which means that:

Over time the 3D feature does not move independently from the observer (i.e., static/rigid position in the world coordinate system),

The distribution of intensity characteristics of the feature does not change significantly over time,

The feature is robust enough that the system could find the right detection algorithm to extract it under normal changes in lighting conditions (i.e., changes which normally occur in the workspace),

The feature is reconstructed and back-projected, using the motion estimated by the external tracker, with acceptable back-projection error,

The subset of the stable features chosen needs to allow accurate localization, compared to a ground truth (reference pose) from the external tracker.

After a predetermined number of stable features are, found, the feature-based pose is compared to the external pose estimation (step 240) and, if the results are acceptable (step 242), the 3D modeled features and covariances are passed on to the tracking phase, as will be described below in conjunction with FIG. 2B. Otherwise, the system will increment to the next frame in the video sequence (step 244) until enough stable features are found to generate an acceptable feature-based pose.

1.2 Tracking for Pose Estimation

Once a model is available, conventional feature extractors and trackers are used to extract features and match them against the model for the initial frame and then tracks the features over the consecutive frames in the stream. This process is depicted in FIG. 2B. Initial model matching can be done by an object recognition system. This task does not need to be real-time, i.e., a recognition system that can detect the presence of an object with less than 1 fps (frames per second) speed can be used. Due to the fact that the environment is very restricted, the recognition system can be engineered for speed and performance.

Once the feature-based tracking system has been initialized, i.e., the pose for the current frame is known approximately, it can estimate the pose of the consecutive frames. This estimation is very fast and robust since it uses the same feature-tracking engine as in the learning or training phase and under similar working conditions.

FIG. 2B illustrates the tracking phase of the method of the present invention in detail. The system, in real time, reads in an image from a video camera (step 250). The initial frame requires an initialization (step 252), i.e., the approximate pose from external tracking system (step 258). It is assumed the external tracking system provides an approximate pose for the first frame in the sequence. Using this pose, the correspondences between the extracted features (compiled in steps 254 and 256) and the 3D locations of the learned features (from step 246 of FIG. 2A) are established (step 258). After the initial frame, the correspondences between the 2D features (whose 3D counterpart are already known) are maintained (step 262) using feature tracking (from step 260). The 2D-3D feature correspondences are used for pose estimation (step 264 and 266). This pose is refined by searching new 2D features in the image corresponding to the 3D model as learned in the learning phase (steps 268 through 272). Along with the original 2D features in step 262, the newly found features form an updated set of correspondences (step 270) and, in turn, an updated pose estimation (step 272). The updated correspondences are tracked in the next frame of the sequence (step 274).

2. Implementation

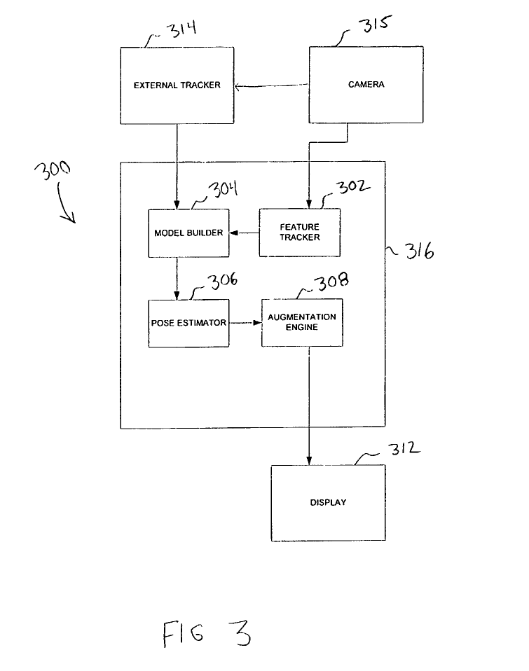

An exemplary system for implementing the method of the present invention is shown in FIG. 3. The system 300 includes (i) an external tracker 314, (ii) a feature tracker 302, (iii) a model builder 304, (iv) a pose estimator 306, and (v) an augmentation engine 308. Additionally, the system 300 includes a camera 315, to be used in conjunction with the feature tracker 302 and/or the external tracker 314, and a display 312.

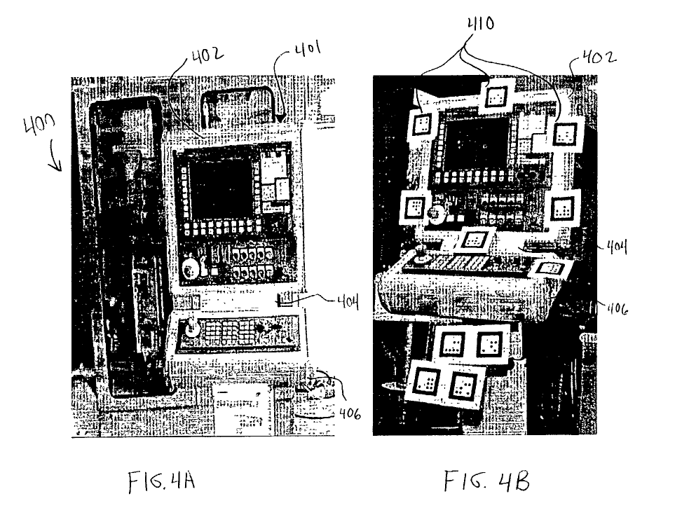

Now, each of the components of the system 300 will be described below in conjunction with FIGS. 4A and 4B which illustrate several views of a workspace where tracking is to take place.

External Tracker (314): Any conventional tracking method can be employed by the system 300 such as mechanical, magnetic, ultrasound, inertial, vision-based, and hybrid. Preferably, a marker-based tracking system, i.e., video-based, is employed since the same images coming from the camera 315 can be used both by the external tracker 314 and the feature tracker 302. Marker-based trackers are commonly available in the computer vision art. The marker-based tracker returns 8 point features per marker. The particular markers 410 used in the present implementation are shown in FIG. 4B, e.g., each marker includes a specific configuration of disks surrounded by a black band. These markers are coded such that the tracker software can identify their unique labels as well as the locations of the corners of the black band surrounding the black disks. This gives 8 corner positions (the corners of the outer and inner rectangles).

Once calibrated in 3D, these point features are used to compute the 6 DOF pose for the camera using an algorithm as described by R. Y. Tsai in “A versatile camera calibration technique for high-accuracy 3D machine vision metrology using off-the-shelf TV cameras”, IEEE Journal of Robotics and Automation, RA-3 (4):323-344, 1987.

Feature Tracker (302): For simplicity, the system only considers point features in tracking. For this, a pyramidal implementation of the Lucas-Kanade algorithm is used, with a pyramid depth of 3 and a search window of the optical flow as 10×10 (see B. D. Lucas and T. Kanade, “An iterative image registration technique with an application to stereo vision”, In Proc. Int. Joint Conference on Artificial Intelligence, pages 674-679). The tracked features are initially selected with the Shi-Tomasi algorithm (see J. Shi and C. Tomasi, “Good features to track”, In Proceedings of the IEEE Conference on Computer Vision and Pattern Recognition, pages 593-600, Seattle, Wash. June 1994). Good features are tracked with the following parameters: quality=0.3, (feature eigenvalue should be greater than 0.3 of the largest one), min distance=20 (distance min between two features) and max number of features=300.

Model Builder (304): Using the points tracked by the feature tracker 302 and the pose provided by the external tracker 314, the system performs an initial reconstruction of the 3D positions of these points using triangulation, as is known in the art. A statistical sampling process, called RANSAC or random sample consensus as is known in the art, is implemented to eliminate points and frames that may be outliers. This is followed by a bundle adjustment process allowing a better estimate of the point locations as well as their uncertainties. The uncertainty information is used later in tracking for pose estimation. Simply, a higher uncertainty in a feature's 3D location means that it is not reliable for pose estimation.

Pose Estimator (306): Given the 2D and 3D point correspondences as compiled by the model builder (304), the pose of the camera 315 is computed, using the Tsai algorithm as described above, based on the features in the workspace. An internal calibration is performed for the camera 315 before the learning or training phase to account for radial distortion up to the 6th degree.

Augmentation Engine (308): In order to show the results, an augmentation engine 308 operatively coupled to display 312 has been provided which overlays line segments representing the modeled virtual objects of the workspace in wire-frame. Each line is represented by its two end points. After the two endpoints of a line are projected, a line connecting the two-projected point is drawn on the image. In the presence of radial distortion, this will present a one-to-one registration between the vertices of the virtual model and their images. However, the virtual line and the image of the corresponding line will not match. One can correct the distortion in the image so that the virtual line matches exactly with the real one.

It is to be understood that the present invention may be implemented in various forms of hardware, software, firmware, special purpose processors, or a combination thereof. For example, in one embodiment, the feature tracker 302, model builder 304, pose estimator 306, and augmentation engine 308 are software modules implemented on a processor 316 of an augmented reality system.

In another embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

3. Experimental Results

To illustrate the system and method of the present invention, several experiments were conducted with the exemplary system 300, the details and results of which are given below.

The first set of experiments tests the learning or training phase of the system.

Referring to FIG. 4A, a workspace 400 to be viewed includes a control panel 401 with a monitor 402, base 404 and console 406. A Sony™ DV camera was employed to obtain several sets of video sequences of the workspace where tracking is to take place. Each video sequence was captured under the real working conditions of the target AR application.

A marker-based tracker was employed as the external tracker, and therefore, as can be seen in FIG. 4B a set of markers 410 was placed in the workspace 400. The markers were then calibrated using a standard photogrammetry process with high-resolution digital pictures. The external tracker 314 provides the reference pose information to the learning phase of the system.

Once the markers 410 are calibrated, i.e., their positions are calculated, the camera used in the experiments was internally calibrated using these markers. Tsai's algorithm, as described above, is used to calibrate the cameras to allow radial distortion correction up to 6th degree, which ensures very good pose estimation for the camera when the right correspondences are provided.

As explained above, while the external tracking provides the AR system with the 6 DOF pose, the learning process extracts and tracks features in the video stream and reconstructs the position of the corresponding three-dimensional features. The 3D position is computed using the pose provided by the external tracker 314. The system, optionally, allows the user to choose a certain portion of the image to allow the reconstruction of scene features only in a corresponding region. This can be desired if the user knows that only those parts of the scene will remain rigid after the learning phase. Otherwise, all the visible features are reconstructed through an automated process.

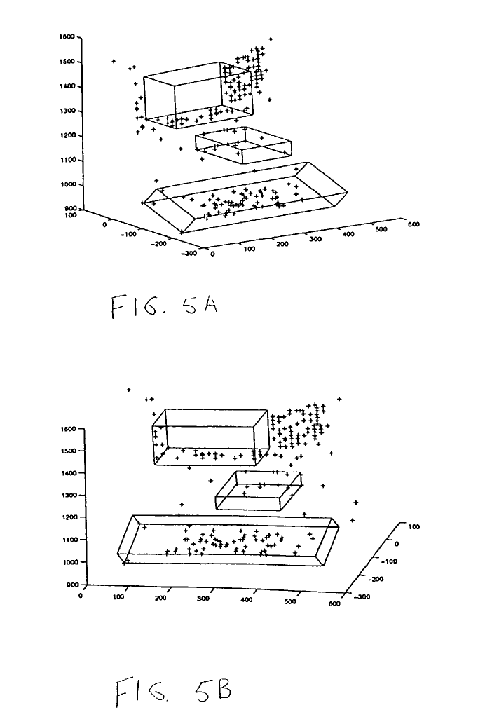

FIGS. 5A and 5B illustrate the results from the learning process where the model of the scene to be tracked is reconstructed. After tracking a set of features in about 100 frames of the video sequence, the system yields a set of reconstructed 3D points. Two views of the combined set of these 3D points are displayed in FIGS. 5A and 5B, where each reconstructed point is represented by a cross. To provide a visual reference for better understanding of the results, three wire-frame boxes are shown alongside the reconstructed 3D points. These wire-frame boxes correspond to three virtual boxes that are placed on top of the monitor screen 402, the base 404 and the console 406 of the control panel shown in FIGS. 4A and 4B.

After the system has learned enough salient features, marker-less tracking is started. A conventional RANSAC type of process can be used to determine the correspondences for the initial pose estimation. Optionally, a recognition system can be employed to estimate the initial pose.

The system uses the reliable features in order to estimate the pose and motion of the observer. The result is then compared with the results obtained by the existing pose estimation system, which is taken as the reference pose or ground truth. The system continues to use the markers until the motion estimated by the feature-based system stays reasonably close to that of the external tracker over a long period of time. At this point, the system let the user know that some markers or all of them can be removed. The system uses the statistical results of the comparison between marker-based and feature-based methods during the learning and motion estimation process and will let the user know whether the overall accuracy of the system would decrease. The user would then make the final decision to remove the markers or keep using them. The aim is that the system would be able to move from marker-based pose determination to the feature-based one in a short period of time, however, in order to insure a safe transition, the system should run for a certain time period to ensure the system has acquired enough reliable “stable” features. For example, if the user works under different lighting conditions, it would be advisable that the system moves to the full use of features only after the system has completed its tests under these different lighting conditions. This means the learning samples used in this process should be representative of the entire set of possible scene variations.

Finally, results of running time performance of the method are provided. The learning part of the system was run off-line. This process is very computationally intensive and does not need to be on-line. The marker-less tracking part of the system runs close to full frame rate (about 22fps) on a 2GHz Intel Pentium TM III processor. This is achieved when a 640×480 video stream is captured from a black-and-white camera through an off-the-shelf frame grabber, e.g., FALCON™ from IDS. When a lower resolution video stream is tracked, e.g., 320×240, the frame rate goes well over 30fps. The processing time may increase slightly depending on the size of the learned-feature set.

Experimental results showed that the method is quite robust even in the presence of moving non-rigid objects occluding the actual scene. Moreover, with an off-the-shelf computer, the tracking and pose estimation can be done in real time, i.e., 30fps.

The present invention provides a method for feature-based pose estimation in video streams. It differs from the existing methods in several ways. First, the proposed method is a two-stage process. The system first learns and builds a model of the scene using off-the-shelve pose and feature tracking methods. After this learning process, tracking for pose is achieved by tracking these learned features.

The second difference is attributed to the way the training or learning phase works. The outcome of the learning process is a set of three-dimensional features with some associated uncertainties. This is not achieved by a structure-from-motion algorithm but by a triangulation or bundle adjustment process. Therefore, it yields more stable and robust features that can be used for accurate pose estimation.

Finally, features on the textures and highlights of objects in a workspace are not very easy to model even if a three-dimensional model of the workspace is available. More importantly, the details of the model may not be particularly suited for the application at hand. The method and system of the present invention can use features on the textures and highlights of objects in the workspace by building an implicit model of the workspace using only the most salient features observable in the given context.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A method for determining a pose of a camera comprising the steps of:
capturing a video sequence by the camera, the video sequence including a plurality of frames;
extracting a plurality of features of an object in the video sequence;
estimating a first pose of the camera by an external tracking system;
constructing a model of the plurality of features from the estimated first pose; and
estimating a second pose of the camera by tracking the model of the plurality of features, wherein after the second pose is estimated, the external tracking system is eliminated.

2. The method as in claim 1, wherein the extracting a plurality of features step is performed in real time.

3. The method as in claim 1, wherein the extracting a plurality of features step is performed on a recorded video sequence.

4. The method as in claim 1, wherein the constructing a model step further comprises the steps of:
tracking the plurality of features over the plurality of frames of the video sequence to construct a 2D-2D match of the plurality of features; and
reconstructing 3D locations of the plurality of features by triangulating the 2D-2D match with the first pose.

5. The method as in claim 4, wherein the estimating the second pose step further comprises the step of matching 2D locations of the plurality of features in at least one frame of the video sequence to the 3D reconstructed locations of the plurality of features.

6. The method as in claim 4, further comprising the steps of:
extracting additional features from the video sequence;
matching 2D locations of the additional features to the 3D reconstructed location of the at least one feature; and
updating the second pose of the camera.

7. The method as in claim 5, wherein an initial matching is performed by object recognition.

8. The method as in claim 1, further comprising the step of evaluating correspondences of the plurality of features over the plurality of frames of the video sequence to determine whether the plurality of features are stable.

9. The method as in claim 1, further comprising the steps of:
comparing the second pose to the first pose; and
wherein if the second pose is within an acceptable range of the first pose, eliminating the external tracking system.

10. A system for determining a pose of a camera comprising:
an external tracker for estimating a reference pose;
a camera for capturing a video sequence;
a feature extractor for extracting a plurality of features of an object in the video sequence;
a model builder for constructing a model of the plurality of features from the estimated reference pose; and
a pose estimator for estimating a pose of the camera by tracking the model of the plurality of features.

11. The system as in claim 10, further comprising an augmentation engine operatively coupled to a display for displaying the constructed model over the plurality of features.

12. The system as in claim 10, wherein the feature extractor extracts the plurality of features in real time.

13. The system as in claim 10, wherein the feature extractor extracts the plurality of features from a recorded video sequence.

14. The system as in claim 10, further comprising a processor for comparing the pose of the camera to the reference pose and, wherein if the camera pose is within an acceptable range of the reference pose, eliminating the external tracking system.

15. The system as in claim 10, wherein the external tracker is a marker-based tracker wherein the reference pose is estimated by tracking a plurality of markers placed in a workspace.

16. The system as in claim 15, further comprising a processor for comparing the pose of the camera to the reference pose and, if the camera pose is within an acceptable range of the reference pose, instructing a user to remove the markers.

17. A program storage device readable by machine, tangibly embodying a program of instructions executable by the machine to perform method steps for determining a pose of a camera, the method steps comprising:
capturing a video sequence by the camera, the video sequence including a plurality of frames;
extracting a plurality of features of an object in the video sequence;
estimating a first pose of the camera by an external tracking system;
constructing a model of the plurality of features from the estimated first pose; and
estimating a second pose of the camera by tracking the model of the plurality of features, wherein after the second pose is estimated, the external tracking system is eliminated.

18. The program storage device as in claim 17, wherein the constructing a model step further comprises the steps of:
tracking the plurality of features over the plurality of frames of the video sequence to construct a 2D-2D match of the plurality of features; and
reconstructing 3D locations of the plurality of features by triangulating the 2D-2D match with the first pose.

19. The program storage device as in claim 18, wherein the estimating the second pose step further comprises the step of matching 2D locations of the plurality of features in at least one frame of the video sequence to the 3D reconstructed locations of the plurality of features.

20. An augmented reality system comprising:
an external tracker for estimating a reference pose;
a camera for capturing a video sequence;
a feature extractor for extracting a plurality of features of an object in the video sequence;
a model builder for constructing a model of the plurality of features from the estimated reference pose;
a pose estimator for estimating a pose of the camera by tracking the model of the plurality of features;
an augmentation engine operatively coupled to a display for displaying the constructed model over the plurality of features; and
a processor for comparing the pose of the camera to the reference pose and, wherein if the camera pose is within an acceptable range of the reference pose, eliminating the external tracking system.
